(19) United States
(12) Patent Application Publication
(10) Pub. No.: US 2007/0109419 A1
(43) Pub. Date: May 17, 2007

(54) Electronic pickup camera and control method of electronic pickup camera

(76) Inventor: Kindaichi Takeshi, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/650,191

(22) Filed: Jan. 5, 2007

Related U.S. Application Data
(62) Division of application No. 10/133,762, filed on Apr. 26, 2002.

(30) Foreign Application Priority Data
Apr. 27, 2001 (JP) 2001-133165

(51) Int. Cl. H04N 5/232

(52) U.S. Cl. 348/211.99

(57) ABSTRACT

An electronic pickup camera which can simply perform the transmission of picked-up image data to an external storage device is disclosed. In an electronic pickup camera including a pickup unit having an electronic pickup element that picks up an object image and an image converter that converts the picked-up image signal to image data of a predetermined format, a storage unit that stores the image data converted by the image converter and a wireless transmission unit that enables wireless transmission of the image data to an external storage device, a control unit that controls at least the pickup unit, the storage unit and the wireless transmission unit such that when the pickup unit is in a non-pickup state, the control unit is adapted to control the camera so that the image data stored in the storage unit are read and transmitted wirelessly by the wireless transmission unit to an external storage device for storing the image data.

### CROSS-REFERENCE TO RELATED APPLICATION

The present application is a divisional application of previously filed U.S. patent application Ser. No. 10/133,762, which is based upon and claims the benefit of priority from the prior Japanese Patent Application 2001-133165, filed Apr. 27, 2001. The entire contents of these applications are incorporated herein by reference.

### BACKGROUND OF THE INVENTION

1. Field of the Invention

The present invention relates to an electronic pickup camera capable of wireless transmission of picked-up image data to an external storage device and a control method thereof.

2. Description of the Related Art

Conventional electronic pickup cameras converted an image signal picked up by an electronic pickup element to compressed data and then stored the compressed data in a semiconductor storage element inside the camera. The semiconductor storage element was also fixedly built into a camera, or in some cases was exchangeable. This semi-conductor storage element had a small storage capacity and could not store a large quantity of image data.

Because the semiconductor storage element is expensive, data stored in the semiconductor storage element are often transmitted to an external storage device and retained there, instead of using one or more semiconductor storage elements having sufficient collective capacity to store all image data.

A personal computer (hereafter referred to as a PC) and PDA (Personal Digital Assistant) are given as examples of an external storage device.

When image data, which have been stored in the semiconductor storage elements of the electronic pickup camera, are transmitted to an external storage device, the electronic pickup camera and the external storage device are connected by a data cable for data transmission. Then, the external storage device drives the electronic pickup camera through the data cable, and reads the image data stored in the semiconductor device within the electronic pickup camera, and stores them in a storage medium of the external storage device.

When transmitting the image data, the electronic pickup camera and the external storage device must be within a range defined by the data cable length for being connected each other. Therefore, when the electronic pickup camera is used at a location far from the external storage device, the electronic pickup camera must be brought within the range where it can be connected with the external storage device by the data cable.

Accordingly, methods for transmitting the image data picked up by the electronic pickup camera to an external storage device by a telephone network (including a cellular telephone network) were thought out. Such techniques are disclosed, for example, in Japanese Published Unexamined Patent Application H11-136612 and Japanese Published Unexamined Patent Application 2000-156813.

Japanese Published Unexamined Patent Application H11-136612 discloses a technique for correlating specified destination information (ID numbers, telephone numbers and so on) of transmission to the image data. In this technique, both the image data and the specified destination information are stored in a memory (a storage medium such as built-in solid memory, a flexible disk, or memory card and the like) of an electronic pickup camera.

In this electronic pickup camera, since the specified destination information is stored with the image data in the storage medium, the image data stored in the memory unit can be automatically transmitted to an external device based on the specified destination information stored with the image data, by an image transmitter such as a cellular telephone or the like. Alternatively, the image data with a specified destination information already transmitted to a PC through a interface (an infrared interface and so on), can be automatically transmitted from the PC to an external device based on the specified destination information.

Therefore, in the electronic pickup camera, it is unnecessary to enter an ID number or telephone number of a destination for transmission of the picked-up data.

For example, when a cellular telephone is connected with the electronic pickup camera for transmission of the image data, it is unnecessary to enter the ID number or telephone number of a destination on the cellular telephone. Moreover, it is also unnecessary to specify the ID number or telephone number or the like of the transmission destination of the image data on a PC when the image data has already been transmitted to the PC and is to be transmitted to the destination.

Therefore, in the electronic pickup camera, transmission operations are not complicated, even if the transmission destinations are different for each image data.

Japanese Published Unexamined Patent Application 2000-156813 discloses a technique wherein an electronic pickup camera having a data transmission function is connected to (1) a navigation device having a position detecting device such as a GPS or the like and (2) wireless transmitter such as a cellular phone. This electronic pickup camera, based on the position information detected by the position detector, detects a data transmissible region along it's moving path, and determines whether or not the current position is in the data transmissible region. When it is determined that the camera is in the transmissible region, the wireless transmitter is controlled to transmit image data stored in a memory card to a desired destination.

Therefore, in the electronic pickup camera, it is unnecessary to confirm whether an operator is in a data transmissible region even when picked-up image data are transmitted via a public wireless network, such as a cellular telephone network or an automobile telephone network or the like. When the location of the camera is outside of the data transmissible region or the operator moves outside of the data transmissible region during the transmission, the image data are not transmitted to prevent transmission errors. Then, when the location of the camera reaches the transmissible region, the image data are transmitted to a desired destination.

In the two electronic pickup cameras disclosed above, however, in transmitting the image data, it was also necessary for an operator to consciously switch the electronic pickup cameras to an operating mode capable of image transmission.

Therefore, it was complicated to transmit image data every time the image pickup was completed. If an operator forgot to transmit the image data and wanted to pick up an image, it was possible that there would be no, or less, recordable capacity in the semiconductor storage element because the storage element was occupied by remaining (i.e., not already transmitted) image data. In this case, there was also the possibility that a good chance of picking up an image would be lost because the camera would be busy for transmitting the image data to make the storage element rewriteable.

One purpose of present invention is providing an electronic pickup camera or a control method of the electronic pickup camera which can accomplish the wireless transmission of the picked up image data without complicated operations.

### SUMMARY OF THE INVENTION

The present invention discloses an electronic pickup camera which accomplishes wireless transmission of image data stored inside of the electronic pickup camera to store the image data in an external storage device, when the pick up camera is in a non-pickup state.

Namely, in an electronic pickup camera comprising a pickup unit having an electronic pickup element that photo-electrically converts an object image to form an image signal and an image converter that converts the image signal formed by the electronic pickup element to image data of a predetermined format, a storage unit that stores the image data converted by the image converter, a wireless transmission unit that is capable of wireless transmission of the image data to an external storage device and a control unit that controls at least the pickup unit, the storage unit and the wireless transmission unit. The control unit reads the image data stored in the storage unit from the storage unit and controls the wireless transmission unit to wirelessly transmit the image data in order to store the image data in the external storage device when the pickup unit is in a non-pickup state.

Thus, if the pickup unit is in a non-pickup state, the image data stored in the storage unit is wirelessly transmitted from the wireless transmission unit to the outside in order to store the image data in the external storage device.

A non-pickup state is a state in which the pickup function of the pickup unit is paused. For example, if the pickup unit transits from an image pickup state capable of picking up an image to a state incapable of picking up an image, the pickup unit transits to the non-pickup state.

A non-pickup state may also be categorized into a non-pickup state capable of wireless transmission to the external (state 1) and a non-pickup state free from wireless transmission (state 2). Of course, it may also not be categorized.

As an example of conditions for transition to the non-pickup state, the electronic pick up camera transits to the non-pickup state when the electronic pick up camera has not been operated for such a time period that time count of not-operated period exceeds a predetermined value. As another example, the electronic pick up camera transits to the non-pickup state when a power switch is turned off by an operator.

It is preferable to construct an electronic pickup camera such that when it is in non-pickup state, it may transit from the non-pickup state to the pickup state instantaneously by using some predetermined operator's operations as triggers for transition.

It is preferable that, in the non-pickup state, only parts required to be active during the non-pickup state are activated (driven) to conserve power. In the non-pickup state, for example, the camera may be constructed so as not to supply power to the pickup unit while supplying power to the wireless transmission unit. When the non-pickup state free from the wireless transmission (state 2) described above exists, however, it is more preferable that power is also not supplied to the wireless transmission unit in state 2.

It is preferable that a wireless transmission link between an external storage device and the electronic pickup camera is established by a procedure in which one side responds to a communication request from the other. There are two ways to do this. In the first way, the electronic pickup camera responds to a communication request from the external equipment to establish a link, while in the second way, the external equipment responds to the communication request of the electronic pickup camera to establish a link. If the electronic pickup camera comes into the non-pickup state, it is preferable to try to establish a link by the first and/or second link establishment technique. By using such techniques it is unnecessary to input an ID number or a telephone number to specify a partner. Accordingly, it is also unnecessary to use large input equipment such as a keyboard or the like at the transmission. Bluetooth® is given as an example of such a communication standard.

It is preferable that, in the non-pickup state, only the image data that have not been transmitted to the outside are selected as the image data to be transmitted. If this is the case, image data which failed to be transmitted becomes the next transmission object. Therefore, it becomes unnecessary to confirm whether all image data can be transmitted while a moving operator remains in the transmissible region. It also becomes unnecessary to check transmission errors strictly.

It is preferable that, in the non-pickup state, (successfully) transmitted image data are deleted automatically from the storage unit of the electronic pickup camera. If this is the case, the storage unit is used efficiently because the image data already transmitted are deleted automatically and more storage space therefore becomes available.

Conversely, it is preferable to prohibit the deletion of image data which have not been transmitted to the outside by providing such data with a special “deletion prohibition” attribute. When the deletion of image data with the deletion prohibition attribute is attempted, the display unit of the camera should display a warning of deletion prohibition. If this is the case, the inappropriate or inadvertent deletion of untransmitted image data may be prevented.

It is preferable that, in the non-pickup state, a lens barrel having an optical pickup system is automatically retracted into the main body of the electronic pick up camera for protecting the optical system.

The electronic pickup camera of the present invention is not limited to a dedicated camera device. Rather, the invention may be used in all electronic devices able to take or store electric pictures (including a cellular telephone, a PDA, a wrist watch, a note PC) are taken as targets.

### BRIEF DESCRIPTION OF THE DRAWINGS

FIG. 1 is a block diagram showing the construction of an electronic pickup camera in an embodiment of an electronic pickup camera relating to the present invention.

FIG. 2 is a flow chart illustrating image pickup actions and image storage actions in an embodiment of an electronic pickup camera relating to the present invention.

FIG. 3 is a flow chart illustrating the transmission of electronic image data in an embodiment of an electronic pickup camera relating to the present invention.

### DETAILED DESCRIPTION

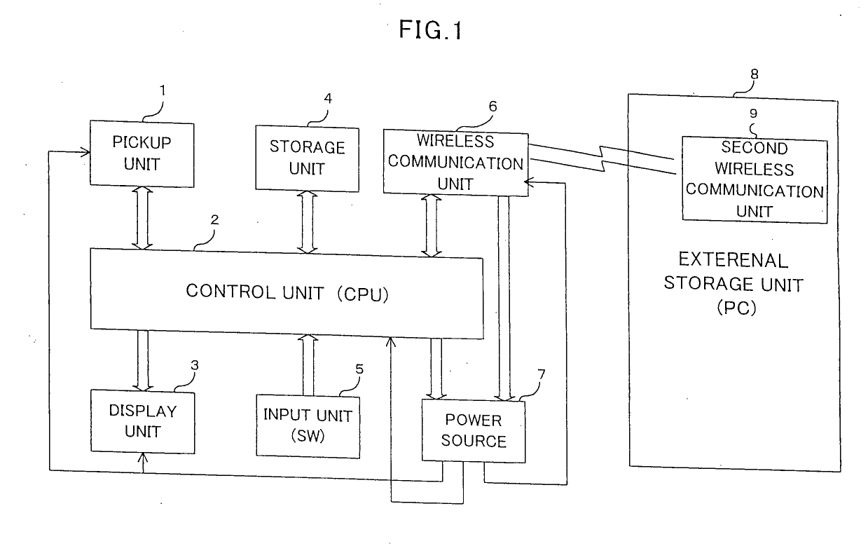

An embodiment of the present invention is illustrated in detail hereafter, with reference to the drawings below. FIG. 1 is a block diagram showing the construction of electronic pickup camera of this embodiment.

As shown in FIG. 1, the electronic pickup camera of this embodiment includes a pickup unit 1, a display unit 3, a storage unit 4, an input unit 5, a wireless communication unit 6 and a power source 7, all connected to a control unit 2. The pickup unit 1 has an electronic pickup element that photo-electrically converts an object image to form an image signal and an electronic converter that converts the image signal formed by the electronic pickup element to image data of a predetermined format. Moreover, an external storage device 8 having a second wireless communication unit 9 is provided outside of the electronic pickup camera.

The electronic pickup element photoelectrically converts an object image to form an analog image signal. The image converter digitalizes the formed analog image signal and may further convert the digital image signal to compressed image data of the predetermined format. Solid-state pickup elements, such as those known as CCD and CMOS, are given as examples of the electronic pickup element.

The image converter is realized by electronic circuits, elements, software or the like.

The display 3 displays the pickup image based on the image data formed by the pickup unit 1 and operating information. For example, a liquid crystal component may be adopted as the display 3. The storage unit 4 stores the image data formed by the pickup unit 1. For example, a non-volatile semiconductor memory may be adopted as the storage unit 4. The non-volatile semiconductor memory may be fixed in the electronic pickup camera or made to be freely detachable.

A release switch, a power switch, a zoom switch and an automatic transmission setting switch for the image data may be included in the input unit 5. The release switch instructs the pickup of an object. If the power switch is turned ON, the control unit 2 feeds out the lenses of a pickup optical system located at a retracted position to a wide-angle position capable of image pickup and starts the power supply from the power source 7 to components of the electronic pickup camera.

If the power switch is turned OFF, the control unit 2 drives the pickup optical system to be retracted into the electronic pickup camera body and partially or wholly stops the power supply from the power source 7 to the components of the electronic pickup camera. In this embodiment, after the power switch is turned OFF, only the power supply to parts that aren't used during the image data transmission is stopped. The automatic transmission setting switch of image data is a switch which functions as a specifying unit for specifying whether the image data stored in the storage unit 4 are automatically transmitted to the outside in order to store the image data into the external storage device via the wireless communication unit 6.

The wireless communication unit 6 functions to transmit the image data stored in the storage unit 4 to the external storage device for storage. For example, the wireless communication unit 6 may comprise a circuit that applies an appropriate communication protocol to the image data and transmits these data wirelessly.

The power source 7 supplies power to the entire electronic pickup camera. Batteries having appropriate capacity and voltage may be used as the power source 7. It is more preferable if power from an external power source is also available. The power from the power source 7 is continuously supplied to the control unit 2 and the wireless communication unit 6, at least when transmitting the image data, even if the power switch is turned OFF.

The control unit 2 controls and drives the entire electronic pickup camera including the pickup unit 1, display unit 3, storage unit 4, input unit 5, wireless communication unit 6 and power source 7. For example, the control unit 2 may be a CPU.

The electronic pickup camera enables wireless transmission of the image data stored in the storage unit 4 to the second wireless communication unit 9 of the external storage device 8 via the wireless communication unit 6. The transmitted image data are stored in the external storage device 8. Bluetooth® is an exemplary wireless communication standard that may be used in the data transmission between the wireless communication unit 6 of the electronic pickup camera and the second wireless communication unit 9 of the external storage device 8.

Bluetooth® is a standard of a short range wireless communication for connecting various digital equipment such as cellular telephones, PDAs, notebook PCs, digital cameras, and printers and the like, and is set up by a standardization group Bluetooth SIG (Special Interest Group). In the present application, the term Bluetooth® is not used as a trademark but is used as a standard name. Namely, in the present application, Bluetooth® means the communication standard prescribed by Bluetooth SIG and as well as a communication standard given by modifying, expanding and changing the Bluetooth®.

Various PCs, PDAs or the like are provided as examples of the external storage device 8. These PCs or PDAs may be provided with the second wireless communication unit 9 adopting the Bluetooth®, or a cellular telephone adopting the Bluetooth® standard may be connected to PCs or PDAs, and the cellular telephone may also be regarded as the second wireless communication unit 9.

Of course, a communication method useable in the present invention (i.e., communication method between the wireless communication unit 6 on the electronic pickup camera side and the external second wireless communication unit 9) is not limited to the Bluetooth. Other wireless communication methods are useable. It is preferable that the data transmission is started based on a communication request from either the electronic pickup camera or the second wireless communication unit 9. It is further preferable that the electronic pickup camera and the external second wireless communication unit keep information for confirming each other, certifying the partner before transmitting or receiving the image data, to prevent transmitting the image data to a wrong transmission partner. Mutual addresses (e.g., IP address) or ID numbers are given as examples of such information.

Moreover, the second wireless communication unit 9 may be provided separate and far from the external storage device 8 and an additional data transmission path may lie between the two. For example, it may be so constructed that the image data from the electronic pickup camera are received by a cellular telephone located near the electronic pickup camera (as a second wireless communication unit 9) and the image data received by this cellular telephone are transmitted to a remote external storage device (e.g., PC) via a cellular telephone network. If so, an operator of the electronic pickup camera can simply transmit the image data from their location to their home PC.

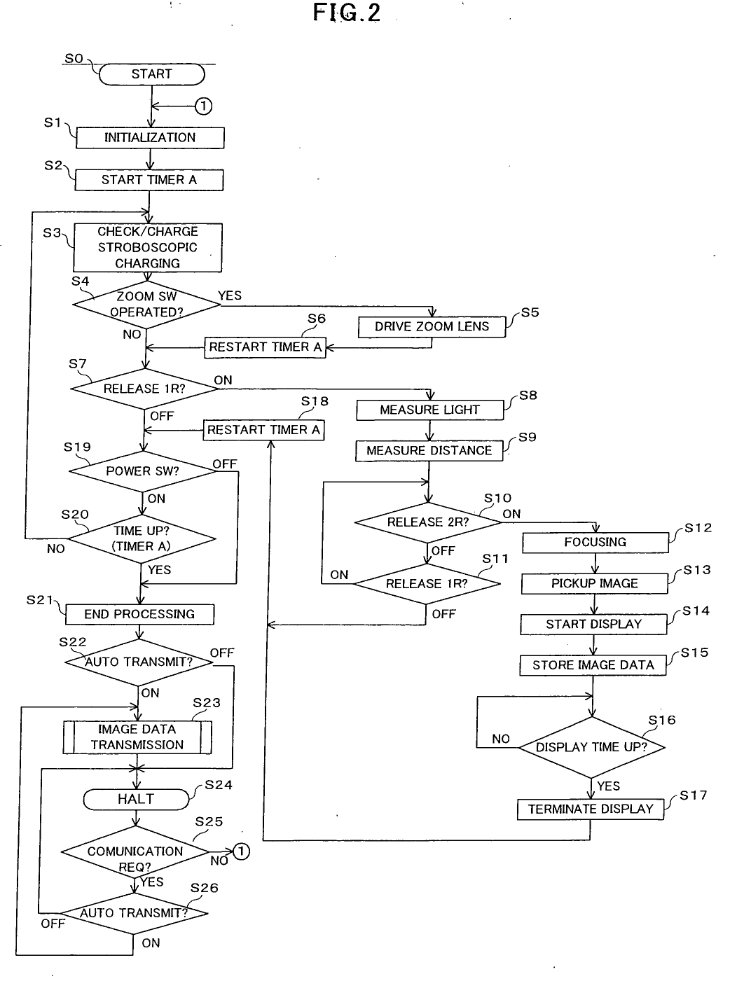

FIG. 2 is a flow chart illustrating how the control unit 2 controls a pickup exposure operation and recording operation of the image data.

When the power switch of the input unit 5 (not-illustrated) is turned ON by the operator, power from the power source 7 is supplied to the control unit 2, the pickup unit 1, the display unit 3 and the wireless communication unit 6, and the control unit 2 starts initialization (Step S1). In the initialization, the control unit 2 controls the pickup optical system to feed out from retracted position sunken in the body of the electronic pickup camera to the wide-angle end position capable of image pickup and puts the electronic pickup camera into a state capable of pickup.

When the initialization of Step S1 is completed, the control unit 2 starts a built-in timer A (not-illustrated) to initiate the measurement of the elapsed time (Step S2). The timer A measures the elapsed time for which the input unit 5 is not operated. When the input unit 5 is operated at some time, the timer A is reset, and the elapsed time is measured from that time of input unit 5 operation.

After the control unit 2 starts the timer A at the Step S2, it checks a charge of a power condenser for stroboscopic light emission (not-illustrated). When the charge of the charge condenser does not satisfy a predetermined amount, charging process is performed (Step S3).

Next, the control unit 2 determines whether a zoom lens operating switch (not-illustrated) provided in the input unit 5 is operated and zooming in or zooming out is indicated (Step S4). If the zoom lens operating switch is not operated, the method proceeds to Step S7.

In the Step S4, if zooming in or zooming out is determined to be indicated, the control unit 2 drives the zoom drive function (not-illustrated) to zoom in or zoom out and drives the pickup optical system (Step S5). More specifically, if zooming in is indicated, the control unit 2 drives the zoom drive function so as to feed out the pickup optical system from the wide-angle end side to the telescopic end side, while if zooming out is indicated, the control unit 2 drives the zoom drive function so as to feed in the pickup optical system from the telescopic end side to the wide-angle end side. Next, the control unit 2 restarts the timer A in the Step 6. The restart of the timer A may also (or alternatively) be executed before Step S5. Then, the control unit 2 executes Step S7. In Step S7, the control unit 2 determines if the release switch of input unit 5 is turned ON.

The release switch is a switch operated in two stages. First, a first release switch (1R) is turned ON in a half-pushed state to measure the object distance and the object brightness. Second, if a second release switch (2R) is turned ON in a fully-pushed state, the pickup optical system is focused based on the measuring result of the object distance, and the aperture stop value of the pickup optical system and the electronic shutter seconds of the pickup element of the pickup unit 1 are established based on the measurement results of object brightness to pick up an object image.

Actions relating to this release switch are illustrated in Steps S8 to S18 below.

If the first release switch (1R) is determined to be turned ON in Step S7, the control unit 2 drives a light-measuring function (not-illustrated) to measure the object brightness (Step S8). Well-known light-measuring methods are used as the light-measuring function. As such light-measuring methods, a method wherein the brightness value is computed from an object image signal exposed and photoelectrically converted by the pickup element of the pickup unit 1 and a method wherein the object brightness value is computed from a photoelectric current generated by a light of object incident into a light-measuring element are given.

Next, the control unit 2 drives a well-known distance-measuring function for measuring the distance to an object (not-illustrated) to measure the distance to the object (Step S9). A triangulation method is an example of well-known distance-measuring method.

There are a passive mode, an active mode and a hybrid mode combining the passive mode and the active mode in the triangulation method. In the passive mode, lights from an object are received by a pair of line sensors respectively, and the output of these line sensors are compared with each other to measure the distance to the object. When the brightness and the contrast of the object are low, an auxiliary light source such as a stroboscopic lamp or the like for irradiating a light onto the object for illumination is also provided.

In the active mode, the distance to the object is measured by using an infrared light-emitting element for projecting an infrared beam onto the object and a position-detecting element provided separate from the infrared light-emitting element by predetermined base line length. The position-detecting element detects the infrared beam light emitted from the light-emitting element and reflected from the object to measure the distance to the object.

When the distance measurement is ended, the control unit 2 determines whether the second release switch (2R) is turned ON or OFF (Step S1). When the second release switch (2R) is turned OFF, the control unit 2 determines if the first release switch (1R) is turned ON (Step S11). When the first release switch is also turned OFF in the Step S11, the control unit 2 moves to Step S18, where the timer A is restarted without picking up an image. On the other hand, when the first release switch is still turned ON in the Step S11, the control unit 2 returns to the Step S10 and determines if the second release switch ON again.

In the Step S10, if the second release switch (2R) is determined to be ON, the control unit 2 drives a focusing function of the pickup optical system (not-illustrated) to adjust the pickup optical system to the focus position by using the distance value measured in the Step S9 (Step S12).

Next, the control unit 2 drives the pickup unit 1 to pick up an object image (Step S13). Namely, The control unit 2 determines an aperture stop value of the pickup optical system and an exposure time of the pickup element of pickup unit 1 by using the object brightness measured in the step S8. During object image pickup (Step S13), the control unit 2 drives the aperture stop of the pickup optical system according to the determined aperture stop value, and drives an electric shutter according to the determined exposure time to expose the object image onto the pickup element. The image picked up by the exposure process is photo-electrically converted to an analog image signal.

Moreover, when the object is determined to be too dark according to the light measurement results of the Step S8, a stroboscopic light may be also emitted to illuminate the object. The analog image signal is converted to a digital signal and may be further compressed to generate compressed digital image data of the predetermined format by the image data converter. The compression format of image signal may be JPEG, or the like, for example.

When the pickup process ends, the control unit 2 converts the compressed digital image data to image data suitable for display and supplies the image data to the display unit 3 for displaying the picked-up image (step S14).

Furthermore, when the picked-up object image is displayed in the display unit, the control unit 2 starts a built-in timer B (step not shown) to measure an elapsed time of displaying the image on the display unit 3.

Next, the control unit 2 stores the compressed digital image data formed by the pickup unit 1 in the storage unit 4 (Step S15). In one exemplary embodiment, when the compressed digital image data are stored in the storage unit 4, address data of the storage unit 4 at which the compressed digital image data are stored and attribution data for specifying whether the stored image data can be deleted may be stored together.

When the storing process of the image data into the storage unit 4 ends, the control unit 2 determines an elapsed time of the timer B started when the pickup image is displayed on the display unit 3 in the Step S14 (Step S16). When the measured elapsed time exceeds a predetermined time period in Step S16, the control unit 2 stops the display of the pickup image in the display unit 3 (Step S17). When the measured elapsed time has not exceeded a prescribed time period in Step S16, the Step 16 is repeated until it exceeds the prescribed time period.

As described above, when the first release switch is determined to be ON in Step S7 and the second release switch is determined to be ON in Step S10, the object image is picked up and the image data are stored in the storage unit 4. Moreover, the image data are displayed in the display unit 3 for a predetermined time period. Subsequently, the control unit 2 restarts the timer A (Step S18) and goes to a Step 19. The object image is not picked up in all other cases. Referring to Step S7, if the first release switch is determined to be OFF, the method proceeds to Step S19.

In Step S19, the control unit 2 determines if the above power switch is in the ON state, like the initialization of Step S1. If the ON state of the power switch is confirmed, the control unit 2 determines if a predetermined time has elapsed since the timer A started in the Step S2 (or since the timer was restarted in Step S6 or S18) (Step S20). If the predetermined time has not elapsed, the control unit 2 returns to Step S3, executes a stroboscopic charging check again and continuously maintains a state capable of picking up an object image.

On the other hand, when the power switch is determined to be OFF in the Step 19 or the predetermined time has elapsed from the start (or restart) of timer A, the control unit 2 performs the END process of the electronic pickup camera (Step S21).

In this END process, the pickup optical system is fed into the retracted position. Moreover, the control unit 2 continues the power supply from the power source 7 to the storage unit 4 and the wireless communication unit 6, but stops the power supply from the power source 7 to the pickup unit 1 and the display unit 3.

At this point, the pickup unit 1 is considered to be in a non-pickup state. In this embodiment, when the input unit 5 is not operated for a predetermined time or longer, or when the power switch is turned OFF, the electronic pickup camera enters a non-pickup state. However, it is possible that the pickup unit 1 enters a non-pickup state under other conditions. For example, when the storage unit 4 is fully loaded with picked-up image data and can not store more image data, or when the voltage of power source 7 is insufficient for image pickup, the pickup unit 1 may also be set up so as to enter a non-pickup state. Moreover, a switch for forcing the pickup unit 1 to enter a non-pickup state may also be provided. The non-pickup state of the pickup unit 1 may be equivalent to the non-pickup state of the electronic pickup camera.

When the above END process ends, the control unit 2 determines a state (ON or OFF) of an image data automatic transmission setting switch provided in the input unit 5 (step S22). The image data automatic transmission setting switch is for setting whether the automatic transmission of the image data stored in the unit 4 is to be performed or not.

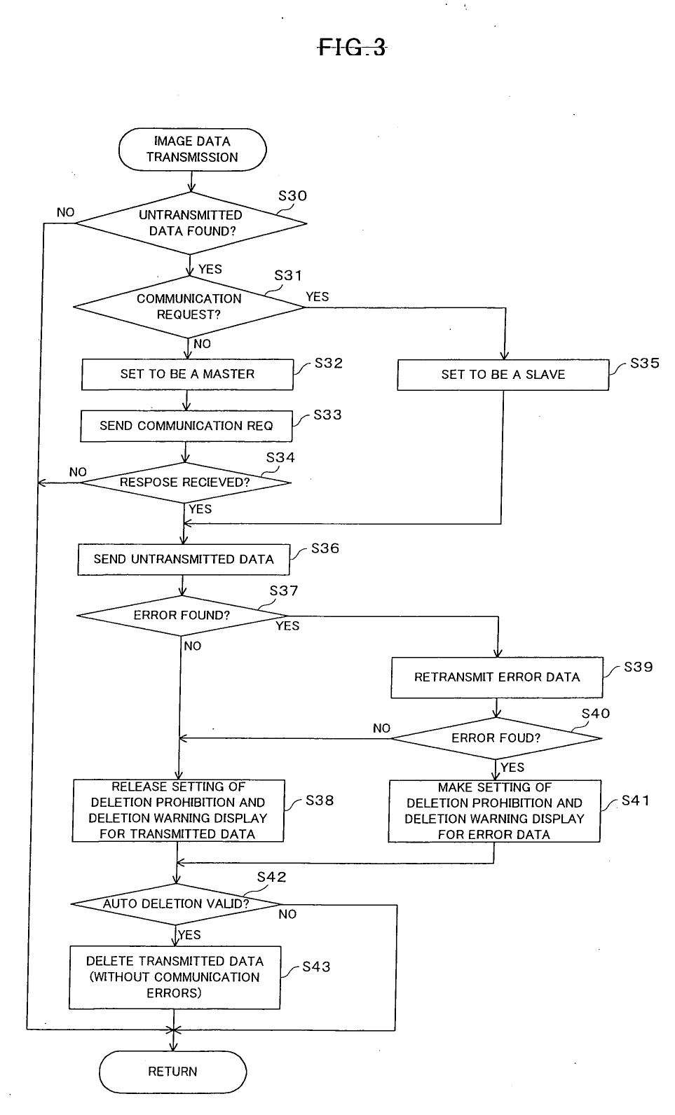

When the automatic transmission setting switch is ON, the control unit 2 performs the automatic transmission of image data to store the image data in the external storage device 8. Namely, the control unit 2 reads the image data stored in the storage unit 4 and drives the wireless communication unit 6 to perform wireless communication with the second wireless communication unit 9 of the above external storage device 8 and transmits the image data (Step 23). Moreover, details of the transmission of image data in one exemplary embodiment will be described hereafter, with reference to FIG. 3.

If the automatic transmission setting switch is determined to be OFF in the Step S22 (the automatic transmission of image data is not performed in this case) or the automatic transmission of image data of Step S23 is ended, the control unit 2 brings the electronic pickup camera to the Halt state (Step S24).

The Halt state is a power-saving state and a standby state. In the Halt state, many functions including the pickup function of the electronic pickup camera are halted, but the wireless communication unit 6 is able to receive the communication request signal for image data from the second wireless communication unit 9. If the power switch of the electronic pickup camera is turned ON or the wireless communication unit 6 receives the communication request signal for image data in the Halt state, the Halt state ends. An electronic pickup camera that has been kept unused for some time period enters the Halt state.

The Halt state of Step S24 may be left when the second wireless communication unit 9 transmits a communication request signal for image data, and the wireless communication unit 6 receives the communication request signal, and the received information is transmitted to the control unit 2, or when the power switch is turned ON.

When the Halt state ends, the control unit 2 determines if it is a communication request signal for image data from the second wireless communication unit 9 (Step S25).

If the request signal is determined to have been received, the control unit 2 determines if the automatic transmission setting switch in the input unit 5 is ON for setting the automatic transmission (Step S26), and if the switch is determined to be ON, the control unit 2 returns to the Step S23 to execute image data transmission. If the switch is determined to be OFF (i.e., set to not enable automatic transmission), the control unit 2 returns to the Step S24 to reenter the Halt state.

In the above Step S25, if the image data communication request signal is determined to have not been received, the control unit 2 moves to the Step S1.

Thus, in this embodiment, the electronic pickup camera is started by the power switch, and the image data formed through the pickup procedure in the Steps S1-S18 by the pickup unit 1 are stored in the storage unit 4. When the power switch of the electronic pickup camera is turned OFF, or when the camera is not operated for a predetermined time or longer, the image data are automatically transmitted to the external storage device 8 (however, only if the automatic transmission switch of image data is set to be ON). Moreover, this transmission is also enabled by an image data communication request from the external storage device 8.

Next, detailed image data transmission of the Step S23 are illustrated by FIG. 3.

The control unit 2 checks if untransmitted image data are stored in the storage unit 4 (Step S30). If no untransmitted image data are found, the control unit 2 returns to execute the Halt of Step S24 in FIG. 2.

If untransmitted image data are found, the control unit 2 determines if the wireless communication unit 6 receives (or received) an image data communication request signal from the second wireless communication unit 9 of the external storage device 8 (Step S31).

In the above Step S31, if the control unit 2 determines that the wireless communication unit 6 does not receive (or has not received) the image data communication request signal from the second wireless communication unit 9, the control unit 2 sets the wireless communication unit 6 as a master of the communication and makes a setting for transmitting the image data stored in the storage unit 4 to the external storage device 8 via the second wireless communication unit 9 (Step S32). Then, the control unit 2 drives the wireless communication unit 6 and sends a communication request for wireless communication to the second wireless communication unit 9 (Step S33).

Next, the control unit 2 determines whether or not a response to the request signal sent in the Step S33 is received (Step S34). The external storage device 8 outputs the response as a reply to the request signal via the second wireless communication unit 9. When the image data communication request signal from the wireless communication unit 6 is received by the second wireless communication unit 9, the external storage device 8 determines if the image data transmission is acceptable, and if the image data are determined to be acceptable, the external storage device 8 outputs a response signal of image data acceptance from the second wireless communication unit 9 to the wireless communication unit 6.

In Step S34, if no response of image data acceptance from the external storage device 8 is received, the control unit 2 returns to execute the Step S24 in FIG. 2.

Although, in this embodiment, the image data communication request from the above-mentioned electronic pickup camera is only sent once, it may be periodically tried a plurality of times until a response signal is detected, or it may be retried a predetermined number of times.

On the other hand, if there is a response of image data acceptance, a link is established between the wireless communication unit 6 and the second wireless communication unit 9 to execute Step S36 and thereafter.

Referring back to Step S31, if the control unit 2 determines that the first wireless communication unit 6 has received the image data communication request signal from the second wireless communication unit 9, the control unit 2 sets the first wireless communication unit 6 as a slave of the communication and prepares to transmit the image data stored in the above storage unit 4 to the external storage device 8 via the second wireless communication unit 9 according to the request of the external storage device 8 (Step S35). Then, a link is established between the wireless communication unit 6 and the second wireless communication unit 9 to execute Step S36 and thereafter.

In this embodiment, Bluetooth® is adopted as a communication standard for the wireless communication unit 6 and the second wireless communication unit 9. The adoption of Bluetooth® enables both units to become a master or a slave. Namely, when the wireless communication unit 6 receives a communication request from the second wireless communication unit 9, the wireless communication unit 6 is set to be a slave and the second wireless communication unit 9 is set to be a master. Conversely, when the wireless communication unit 6 does not receive a communication request from the second wireless communication unit 9 and receives a response to a communication request sent by the wireless communication unit 6 from the second wireless communication unit 9, the wireless communication unit 6 is set to be a master and the second wireless communication unit 9 is set to be a slave.

When the wireless communication unit 6 and the second wireless communication unit 9 are adopted as a master or a slave and link between the two units has established, Step S36 is executed. In Step S36, the control unit 2 reads the untransmitted image data stored in the storage unit 4. Then, the control unit 2 drives the wireless communication unit 6 to transmit the image data to the second wireless communication unit 9 (e.g., using the Bluetooth® standard) and the transmitted image data is stored in the external storage device 8.

When the transmission ends, the control unit 2 determines if there were any communication errors in Step S36 (Step S37). The detection of communication errors is performed by a communication state monitoring circuit (not-illustrated) which is an error detector contained in the wireless communication unit 6. This communication state monitoring circuit monitors the state of communication and may be used to detect timeout and parity errors. If a communication error is detected, the control unit 2 may drive the wireless communication unit 6 to retransmit the image data not successfully transmitted because of the communication errors (Step S39).

Then, the control unit 2 may determine if there were errors in the retransmission of the image data in Step S39 (Step S40). If communication errors are detected in Step S40, the control unit 2 may make the image data affected by the communication error undeletable from the storage unit 4, and displays a warning on the display unit 3 to inform a user that the data is set to be undeletable (Step S41).

If communication errors are not found in the Step S37 or S40, the control unit 2 clears the undeletable attribute of the image data stored in the storage unit 4 and successfully transmitted in the Step S36 or S40, and clears the deletion warning display (Step S38).

Next, the control unit 2 determines if an automatic deletion is possible for each image data stored in the storage unit 4 (Step S42). The determination of automatic deletion depends on the attribution of the image data stored in the storage unit 4. The automatic deletion is valid if the undeletable settings are cleared in the Step 38 (or if they were never set), and is invalid if the undeletable settings are made in Step S41.

Control unit 2 deletes image data determined to be valid for automatic deletion in Step S42 from the storage unit 4 (Step S43). In the deletion process, it is possible to delete only directory information of the image data, but it is also possible to delete the whole image data and the directory information. If the transmission of all image data stored in a semiconductor storage medium is completed normally, the semiconductor storage medium itself may be formatted.

However, the control unit 2 does not delete image data which were not determined to be valid for automatic deletion in Step S42 from the storage unit 4.

Subsequently, the control unit 2 returns to execute the Halt in Step S24 in FIG. 2.

Thus, after the pickup actions of the electronic pickup camera, when the power switch is turned OFF or the electronic pickup camera is not operated for a prescribed time, the electronic pickup camera enters a non-pickup state. In the non-pickup state, power from the power source 7 is supplied to at least the wireless communication unit 6, but is not supplied to at least the pickup unit 1 for energy conservation. In the non-pickup state, if there are picked-up image data in the storage unit 4 and that image data have not been transmitted to the external storage device 8 (i.e., the image data were not transmitted because of communication errors, or newly stored in the storage unit 4), the control unit 2 tries to transmit the image data to the external storage device 8. There are two ways this transmission may take place. In the first way, a transmission request is made for the external storage device 8, and if and when a permission for transmission reception is obtained from the external storage device 8, the image data stored in the storage unit 4 is transmitted (a case where the electronic pickup camera is adopted as a master to send the image data). In the second way, the image data is transmitted corresponding to a communication request from the external storage device 8 (a case where the electronic pickup camera is adopted as a slave to send the image data). It is preferable that both ways can be adopted, but either way is also possible.

Extra capacity to store new image data in the storage unit 4 becomes available because the image data (successfully) transmitted to the external storage device 8 are automatically deleted from the storage unit 4.

Of course, it also possible that normally transmitted image data are not deleted from the storage unit 4 and their attributions are changed so that the image data can be over-written. If so, a transmitted image can be displayed in the display unit 3 because the image data remains in the storage unit 4 even after the transmission. Since these image data are possibly over-written, it is not troublesome to receive new image data into the storage unit 4 when the capacity of the storage unit 4 is low.

Moreover, in this embodiment, the electronic pickup camera enters a non-pickup state after the image pickup of the electronic pickup camera is finished. But it is also useful that the electronic pickup camera is constructed to enter a non-pickup state when the camera is activated. In this case, the camera first enters a non-pickup state to transmit untransmitted image data remaining in the storage unit 4 to make a room for new image data, then enters a pickup state to pick up images and store them. If so, it is possible to fully secure the residual capacity of the storage unit 4 at the start of image pickup.

Moreover, if the entire electronic pickup camera is locked during the transmission of the image data, malfunctions can be prevented.

If an information device (such as a cellular telephone or PDA or the like) using Bluetooth® standard in communication is adopted as the second wireless communication unit 9, the communication between the wireless communication unit 6 of the electronic pickup camera and the information device are established using the Bluetooth® standard. The image data can also be further transmitted from the information device to another device, such as a personal computer or the like. In this case, the data transmission from the information device to the personal computer or the like is possible by many ways, like wireless communication, wire-connected communication, infrared communication, or carrying portable recording medium like CD-RW by hand.

As described above, the electronic pickup camera disclosed as an embodiment of the present invention transits from a pickup state to a non-pickup state when the power switch is turned OFF or the camera has not been operated for predetermined time or longer. Then, if possible, the electronic pickup camera in the non-pickup state wirelessly transmits the image data in order to store the image data to the external storage device. At this time, if a communication request from outside is received by the electronic pickup camera, the electronic pickup camera becomes a slave of the communication and transmits the image data wirelessly. If no communication request from the outside is received by the electronic pickup camera, the electronic pickup camera becomes a master of the communication and transmits the image data wirelessly. Bluetooth® standard may be used in the wireless communication procedure at this time. Moreover, the data transmission is performed only for untransmitted data, and the transmitted image data may be automatically deleted from the storage unit or marked for overwriting.

Since the electronic pickup camera in this embodiment is constructed as described above, when the pickup unit enters a non-pickup state, the electronic pickup camera attempts to transmit image data to the external storage device automatically. Therefore, if the external storage device is in the image data acceptable state, the transmission of image data is possible at any time.

Accordingly, the image data picked up by the electronic pickup camera can be transmitted to the external storage device without complicated operations required by a user.

What is claimed is:

1. An electronic pickup camera comprising:
a pickup unit having an electronic pickup element that photo-electrically converts an object image to form an image signal and an image converter that converts the image signal formed by the electronic pickup element to image data of a predetermined format;
a storage unit that stores the image data converted by the image converter;
a wireless transmission unit that enables wireless transmission of the image data; and
a control unit that controls at least the pickup unit, the storage unit and the wireless transmission unit, the control unit adapted to control the camera to read out the image data stored in the storage unit and transmit wirelessly the read out image data to an external storage device for storing the read out image data when the pickup unit is in a non-pickup state.

2. The electronic pickup camera according to claim 1 in which,
power is not supplied to the pickup unit in the non-pickup state.

3. The electronic pickup camera according to in claim 1, further comprising a timer unit for measuring a time period during which the electronic pickup camera is not operated,
wherein the pickup unit enters the non-pickup state when a time period measured by the timer unit exceeds a predetermined time period.

4. The electronic pickup camera according to claim 1, further comprising a power switch,
wherein the pickup unit enters the non-pickup state when the power switch is turned off.

5. The electronic pickup camera according to claim 1, further comprising an optical system that enables forming an object image on the light-receiving plane of the electronic pickup element,
wherein the optical system, along with a lens barrel holding the optical system, is automatically retracted into a body of the electronic pickup camera when the pickup unit enters the non-pickup state.

6. The electronic pickup camera according to claim 1 in which,
the wireless transmission of read out image data by the wireless transmission unit is performed for untransmitted image data.

7. The electronic pickup camera according to claim 1 in which,
the wireless transmission of read out image data by the wireless transmission unit starts after the wireless transmission unit sends a communication request.

8. The electronic pickup camera according to claim 1 in which,
the wireless transmission of read out image data by the wireless transmission unit starts after a communication request sent from the external storage unit is detected.

9. The electronic pickup camera according to claim 1 in which,
the wireless transmission of image data by the wireless transmission unit is performed using a Bluetooth standard.

10. The electronic pickup camera according to claim 1 in which,
the external storage unit is one of a personal computer or a personal digital assistant.

11. The electronic pickup camera according to claim 1 in which,
the control unit is further adapted to delete the transmitted image data from the storage unit after they have been read out and successfully transmitted to the external storage unit.

12. The electronic pickup camera according to claim 1 in which,
the control unit is further adapted to set up an attribution of deletion prohibition for image data which have not been transmitted.

13. The electronic pickup camera according to claim 12, further comprising a display unit for displaying information to an operator,
wherein an indicator of the attribution of deletion prohibition is displayed on the display unit.

14. The electronic pickup camera according to claim 1 in which,
the wireless transmission of image of read out data by the wireless transmission unit is automatically performed, and wherein the pickup unit enters the non-pickup state following the wireless transmission.

15. An electronic pickup camera comprising:
a pickup unit having an electronic pickup element that photo-electrically converts an object image to form an image signal and an image converter that converts the image signal formed by the above electronic pickup element to image data of a predetermined format;
a storage unit that stores the image data converted by the image converter;
a wireless transmission unit that enables wireless transmission of image data;
a specifying unit for specifying whether wireless transmission of image data is to be automatically started when the pickup unit enters a non-pickup state; and
a control unit that controls at least the pickup unit, the storage unit and the wireless transmission unit, the control unit adapted to control the camera to read out the image data stored in the storage unit and transmit wirelessly the read out image data to an external storage device when the pickup unit is in the non-pickup state and the specifying unit specifies that the wireless transmission of image data is to be automatically started when the pickup unit enters the non-pickup state.

16. The electronic pickup camera according to claim 15 in which,
power is not supplied to the pickup unit in the non-pickup state.

17. The electronic pickup camera according to in claim 15 further comprising a timer unit for measuring a time period during which the electronic pickup camera is not operated,
wherein the pickup unit enters the non-pickup state when a time period measured by the timer unit exceeds a predetermined time period.

18. The electronic pickup camera according to claim 15, further comprising a power switch,
wherein the pickup unit enters the non-pickup state when the power switch is turned off.

19. The electronic pickup camera according to claim 15, further comprising an optical system that enables forming an object image on the light-receiving plane of the electronic pickup element,
wherein the optical system, along with a lens barrel holding the optical system, is automatically retracted into a body of the electronic pickup camera when the pickup unit enters the non-pickup state.

20. The electronic pickup camera according to claim 15 in which,
the wireless transmission of read out image data by the wireless transmission unit is performed for untransmitted image data.

21. The electronic pickup camera according to claim 15 in which,
the wireless transmission of read out image data by the wireless transmission unit starts after the wireless transmission unit sends a communication request.

22. The electronic pickup camera according to claim 15 in which,
the wireless transmission of read out image data by the wireless transmission unit starts after a communication request sent from the external storage unit is detected.

23. The electronic pickup camera according to claim 15 in which,
the wireless transmission of image data by the wireless transmission unit is performed using a Bluetooth standard.

24. The electronic pickup camera according to claim 15 in which,
the external storage unit is one of a personal computer or a personal digital assistant.

25. The electronic pickup camera according to claim 15 in which,
the control unit is further adapted to delete the transmitted image data from the storage unit after they have been read out and successfully transmitted normally.

26. The electronic pickup camera according to claim 15 in which,
the control unit is further adapted to set up an attribution of deletion prohibition for image data which have not been transmitted.

27. The electronic pickup camera according to claim 26 further comprising a display unit for displaying information to an operator,
wherein an indicator of the attribution of deletion prohibition is displayed on the display unit.

28. The electronic pickup camera according to claim 15 in which,
the wireless transmission of read out image data by the wireless transmission unit is automatically performed, and wherein the pickup unit enters the non-pickup state following the wireless transmission.

29. An electronic pickup camera comprising:
a pickup unit having an electronic pickup element that photo-electrically converts an object image to form an image signal and an image converter that converts the image signal formed by the electronic pickup element to image data of a predetermined format;
a storage unit that stores the image data converted by the above image converter;
a wireless transmission unit that enables transmitting the image data wirelessly;
a power switch; and
a control unit adapted to control the camera to read out and transmit wirelessly by the wireless transmission unit, image data stored in the storage unit when the power switch is turned off.

30. The electronic pickup camera according to claim 29 in which,
the wireless transmission of read out image data by the wireless transmission unit is performed only for untransmitted image data.

31. An electronic pickup camera comprising:
pickup means having an electronic pickup means that photo-electrically converts an object image to form an image signal and image converter means that converts the image signal formed by the electronic pickup means to image data of a predetermined format;
means for storing the image data converted by the above image converter means;
means for transmitting the image data wirelessly to an external storage device; and
means for controlling the camera for reading out and transmitting, by the means for transmitting, the image data stored in the storage means to an external storage device for storing the image data, when the pickup unit is in a non-pickup state.

32. A control method of electronic pickup camera comprising:
photo-electrically converting an object image to form an image signal by a photo-electrical conversion element,
converting the formed image signal to image data of a predetermined format by an image converter;
storing the converted image data in a storage unit; and
transmitting the image data wirelessly to an external storage device,
wherein the acts of photo-electrically converting and storing are performed when a pickup unit including the photo-electrical conversion element and the image converter is in a pickup state, and the act of transmitting is performed when the pickup unit is non-pickup state.

33. The control method of electronic pickup camera according to claim 32 wherein the pickup unit is controlled to enter the non-pickup state when the electronic pickup camera is not operated for a predetermined time or longer.

34. The control method of electronic pickup camera according to claim 32 wherein the pickup unit is controlled to enter the non-pickup state when a power switch of the electronic pickup camera is turned off.

35. The control method of electronic pickup camera according to claim 32 wherein the act of transmitting is performed for untransmitted image data.

36. The control method of electronic pickup camera according to claim 32 further comprising:
deleting successfully transmitted image data after the act of transmitting.

37. The control method of electronic pickup camera according to claim 32, wherein the act of transmitting is automatically performed after the pickup unit enters the non-pickup state.

38. The control method of electronic pickup camera according to claim 32, further comprising:
specifying whether or not the act of transmitting is to be automatically started when the pickup unit enters the non-pickup state,
wherein the act of transmitting is performed automatically when the pickup unit enters the non-pickup state and if it has been specified that the act of transmitting is to be automatically started.

39. The control method of electronic pickup camera according to claim 32 further comprising:
detecting whether untransmitted image data exist in the electronic pickup camera when the electronic pickup camera enters the non-pickup state; and
wirelessly transmitting the untransmitted image data to the external device when the untransmitted image data are detected to exist.

40. The control method of electronic pickup camera according to claim 39 further comprising deleting the image data in the electronic pickup camera whose wireless transmission is completed normally.

41. The control method of the electronic pickup camera according to claim 40 further comprising releasing a setting of deletion prohibition of image data prior to the act of deleting.

42. The control method of the electronic pickup camera according to claim 39 further comprising:
detecting communication errors in the wireless transmission: and
resending image data when the communication errors are detected.
